(19) United States
(12) Patent Application Publication
(10) Pub. No.: US 2021/0024415 A1
(43) Pub. Date: Jan. 28, 2021

(54) METHOD FOR PRODUCING WELL DEFINED COMB POLYMERS

(71) Applicant: SIKA TECHNOLOGY AG, Baar (CH)

(72) Inventors: Jürg WEIDMANN, Winterthur (CH); Markus FRIEDERICH, Schlieren (CH); Christina HAMPEL, Rütihof (CH); Jörg ZIMMERMANN, Winterthur (CH)

(73) Assignee: SIKA TECHNOLOGY AG, Baar (CH)

(21) Appl. No.: 17/043,588

(22) PCT Filed: May 22, 2019
(86) PCT No.: PCT/EP2019/063197

§ 371 Date: Sep. 29, 2020

(30) Foreign Application Priority Data
May 31, 2018 (EP) 18175429.2

(51) Int. Cl. C04B 24/26; C08F 290/06; C08F 293/00

(52) U.S. Cl. CPC C04B 24/2647; C08F 290/062; C04B 2103/408; C08F 2438/03; C08F 293/005

(57) ABSTRACT

A method for producing improved comb polymers having a block or gradient structure. The comb polymers are highly suitable for dispersing fine powder.

### TECHNICAL FIELD

The invention relates to a process for preparing well-defined comb polymers having block or gradient structure and to the use thereof as dispersants.

### STATE OF THE ART

Comb polymers have been used for many years as superplasticizers in concrete processing. It is thus possible to improve the concrete properties, for example processibility and strength. Such comb polymers typically have a polymer backbone with acid groups and polyether side chains bonded thereto. The comb polymers are typically prepared by means of free-radical copolymerization of monomers containing acid groups and of monomers containing polyether chains. Comb polymers can also be obtained by polymer-analogous esterification of carboxyl groups in polycarboxylates, for example polymethacrylic acid, with polyethers capped at one end.

In all these comb polymers, the acid groups and the side chains are in random distribution along the polymer backbone.

As well as the comb polymers with random distribution of the monomer units, there are now also comb polymers having a nonrandom distribution of the acid groups and the side chains along the polymer backbone, for example comb polymers having block or gradient structure.

WO 2015/144886 describes a block copolymer composed of monomers containing acid groups and monomers containing polyether chains as dispersant for mineral binder compositions. The block copolymer contains a block of the monomers containing acid groups and less than 25 mol % of monomers comprising polyether chains, and has a block of the monomers comprising polyether chains and less than 25 mol % of monomers containing acid groups.

WO 2017/050907 describes a copolymer having gradient structure as dispersant for mineral binder compositions. The copolymer comprises ionizable monomer units and side chain-bearing monomer units.

Polyalkylene glycol (meth)acrylates are of especially good suitability for the preparation of comb polymers having block or gradient structure comprising polyalkylene glycol side chains.

WO 2006 024538 describes a process for preparing polyalkylene glycol (meth)acrylate by reacting (meth)acrylic anhydride with a polyalkylene glycol compound bearing at least one OH group in a molar ratio of 1:1 to 1.095:1. This reaction gives rise to one mole of free (meth)acrylic acid per mole of (meth)acrylic anhydride reacted.

EP 0 884 290 describes a process for preparing polycarboxylic acids by esterifying a polyalkylene glycol with an excess of methacrylic acid and then polymerizing the reaction mixture containing the polyalkylene glycol (meth)acrylate and methacrylic acid.

Many commercial polyalkylene glycol (meth)acrylates in technical grade quality contain 5% by weight or more of methacrylic acid.

The removal of the methacrylic acid from the reaction mixture, typically by distillation, means extra complexity, which distinctly increases the costs for the polyalkylene glycol (meth)acrylate and hence for the comb polymer prepared therefrom. The high-temperature needed for the distillation can also lead to unwanted by-products, for example dimethacrylate, which worsen the properties of the polymers prepared therewith, especially their effect as dispersant.

There is therefore still a need for comb polymers having block or gradient structure with improved properties, and improved, inexpensive methods for preparation thereof.

### SUMMARY OF THE INVENTION

It is an object of the present invention to provide a process by which comb polymers having block or gradient structure with improved properties can be prepared. The comb polymers are to be usable as dispersants for fine powders, especially inorganic binder compositions. The process is also to be inexpensive.

This object is surprisingly achieved by a process as described in claim 1.

It has been found that, surprisingly, comb polymers that have been prepared by the process of the invention have improved action as dispersants.

For instance, the comb polymers having block or gradient structure that have polyalkylene glycol side chains in at least one section and contain very few, if any, acid groups in this section have better dispersing action for inorganic powders, especially for hydraulically setting building materials, than comb polymers having block or gradient structure that contain acid groups in the section having the polyether side chains.

It is surprisingly possible to obtain improved comb polymers when a monomer mixture containing a polyalkylene glycol (meth)acrylate that has been prepared by a process in which neither (meth)acrylic anhydride nor the anhydride of (meth)acrylic anhydride has been used for the preparation.

Further aspects of the invention are the subject of further independent claims. Particularly preferred embodiments of the invention are the subject of the dependent claims.

### Ways of Executing the Invention

The invention provides a process for preparing comb polymers having block or gradient structure, wherein at least one section A of the comb polymer is formed by polymerizing a monomer mixture M comprising a polyalkylene glycol (meth)acrylate, wherein the monomer mixture M includes less than 2% by weight of (meth)acrylic acid, based on the weight of the polyalkylene glycol (meth)acrylate present in the monomer mixture M.

The monomer mixture M preferably includes less than 1.8% by weight, more preferably less than 1.6% by weight, especially preferably less than 1.4% by weight, especially less than 1.2% by weight, in particular 0.9% by weight or less, of (meth)acrylic acid, based on the weight of the polyalkylene glycol (meth)acrylate present in the monomer mixture M.

Such a monomer mixture M is of especially good suitability for preparing well-defined block and gradient polymers.

The polymerization of the monomer mixtures M can give comb polymers having at least one polymer section A having only few or no acid groups, which distinctly improve the properties of the comb polymers, especially as dispersant for inorganic powders.

In the present document, “(meth)acrylate” is understood to mean both an ester of methacrylic acid and an ester of acrylic acid.

Correspondingly, “(meth)acrylic acid” is understood to mean both methacrylic acid and acrylic acid.

In the present document, “polyalkylene glycol capped at one end” is understood to mean a polyalkylene glycol having a hydroxyl group at one end and an unreactive group, for example an alkoxy, cycloalkoxy or alkylaryloxy group, at the other end. In the present document, “comb polymer” is understood to mean a polymer comprising a largely linear polymer backbone and side chains. In the present document, a “largely linear” polymer chain is understood to mean one that contains no deliberately introduced branches.

In the present document, “comb polymer having block or gradient structure” is understood to mean a comb polymer in which the monomer units are present in nonrandom sequence, meaning that the sequence is not obtained randomly. Such a sequence is not obtained under the customary conditions of a free-radical copolymerization or a polymer-analogous reaction. In the nonrandom sequence, at least one monomer unit is enriched in at least one section of the polymer backbone.

In the present document, “section” or “section of the polymer chain” is understood to mean part of the polymer backbone including the associated side groups. In the case of block or gradient polymers, the sequence of monomers along the polymer backbone is nonrandom. This means that different sections have different proportions of the monomer units present in the polymer.

In the present document, “monomer mixture” is understood to mean a solution, liquid or solid comprising at least one free-radically polymerizable monomer.

The polyalkylene glycol (meth)acrylate of the monomer mixture M preferably has a structure of the formula I

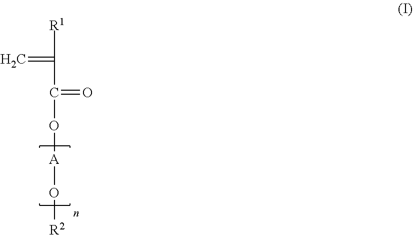

where
R¹, in each case independently, is H or —CH₃,
R², in each case independently, is H, a C₁- to C₂₀-alkyl group, -cyclohexyl group or -alkylaryl group,
A is C₂-C₄-alkylene, and
n=2 to 250.

Advantageously, [A-O]ₙ is polyethylene glycol, polypropylene glycol or a polyether consisting of ethylene glycol and propylene glycol units, wherein the ethylene glycol and propylene glycol units may be arranged in blocks or randomly. Advantageously, the polyether consists of at least 50 mol %, preferably at least 70 mol %, especially at least 90 mol %, of ethylene glycol units.

Especially preferably, [A-O]ₙ is polyethylene glycol.

Preferably, n=5 to 200, more preferably 8 to 160, especially 9 to 130, in particular 10 to 120 or 12 to 70.

Preference is given to a polyalkylene glycol (meth)acrylate that has been prepared by a process in which neither (meth)acrylic acid nor the anhydride of (meth)acrylic acid is used.

The polyalkylene glycol (meth)acrylate is preferably obtained by transesterifying an alkyl (meth)acrylate with a polyalkylene glycol capped at one end or by alkoxylating a hydroxyalkyl(meth)acrylate.

As a result, only a very small amount, if any, of (meth)acrylic acid is present in the monomer mixture. The (meth)acrylic acid need therefore not be removed from the monomer mixture in a complex manner, which saves costs and reduces the formation of possibly troublesome by-products.

In a preferred embodiment, the polyalkylene glycol (meth)acrylate is obtained by alkoxylating a hydroxyalkyl (meth)acrylate, preferably hydroxyethyl (meth)acrylate or hydroxypropyl (meth)acrylate. In this case, R² in the formula I is H.

In this case, the monomer mixture M is preferably obtained by the following steps:
alkoxylating a hydroxyalkyl(meth)acrylate with at least one alkylene oxide using a suitable catalyst, especially up to an average degree of alkoxylation of 2 to 250, and
optionally removing the catalyst and/or adding acid or alkali.

In a specifically preferred embodiment, the polyalkylene glycol (meth)acrylate is obtained by transesterifying an alkyl (meth)acrylate with a polyalkylene glycol capped at one end.

In this case, R² in the formula I is a C₁- to C₂₀-alkyl group, -cyclohexyl group or -alkylaryl group.

In this case, the monomer mixture M is preferably obtained by the following steps:
transesterifying an alkyl (meth)acrylate with a polyalkylene glycol capped at one end up to a conversion of at least 60 mol %, based on polyalkylene glycol capped at one end, with continuous removal of the alkyl alcohol formed from the reaction mixture, and
optionally distilling off excess alkyl (meth)acrylate.

For the transesterification, preference is given to using an alkyl (meth)acrylate of the formula II and polyalkylene glycol capped at one end of the formula III:

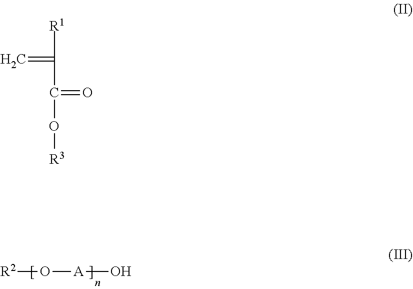

where
R¹, R², A, [A-O]ₙ and n are as described above, where R² here is not H⁺, and
R³, in each case independently, is an alkyl group having 1 to 5 carbon atoms, preferably a methyl or ethyl group, especially a methyl group.

Preferably, n in formula III is an integer from 10 to 120, especially 12 to 70.

It is preferable that the alkyl (meth)acrylate of the formula II is methyl methacrylate.

It is preferable that the polyalkylene glycol capped at one end of the formula III is polyethylene glycol monomethyl ether.

The transesterification is advantageously conducted with an excess of alkyl (meth)acrylate.

Preferably, at the start of the transesterification reaction, the molar ratio of alkyl (meth)acrylate to polyalkylene glycol capped at one end is 1:1 to 50:1, especially 1.5:1 to 20:1, in particular 2:1 to 10:1.

An excess of alkyl (meth)acrylate can increase the reaction rate and improve the reaction conversion.

Advantageously, the transesterification is conducted at elevated temperature, for example at 40 to 100° C.

Advantageously, an esterification catalyst is used for the transesterification. All standard catalysts are suitable in principle. Suitable catalysts are, for example, alkaline or acidic catalysts.

Particularly advantageous catalysts are alkali metal hydroxides, alkaline earth metal hydroxide, alkali metal carbonates, alkali metal alkoxides, sulfuric acid, sulfonic acids such as p-toluenesulfonic acid, strongly basic or acidic ion exchangers, phosphorus compounds, for example phosphoric acid, phosphonic acid or hypophosphorous acid or salts thereof, or titanium or zirconium compounds. Such transesterification catalysts are known to the person skilled in the art.

If a catalyst that disrupts a living free-radical polymerization, especially by means of the RAFT mechanism, is used, it is advantageously removed from the reaction mixture before it is used for preparation of the comb polymer.

Preference is given to a catalyst that does not disrupt living free-radical polymerization and therefore need not necessarily be separated from the reaction mixture.

In order to prevent polymerization of the alkyl (meth)acrylate and/or the polyalkylene glycol (meth)acrylate during the transesterification, a polymerization inhibitor is advantageously used. Polymerization inhibitors are known to the person skilled in the art. Nonlimiting examples of inhibitors are hydroquinone, hydroquinone methyl ether, phenothiazine or phenols.

The dosage of the inhibitor is advantageously chosen at a sufficiently high level that polymerization of the monomers during the transesterification reaction is prevented, but only at such a high level that the dosage of the polymerization initiators for a subsequent polymerization is not excessively high.

It is preferable that, during and/or after the transesterification, excess alkyl (meth)acrylate is partly or fully removed from the reaction mixture, especially distilled off.

This is advantageous especially when a large excess, especially more than 10 times the molar amount, of alkyl (meth)acrylate was used in the transesterification.

It is preferable that the reaction mixture obtained after the transesterification reaction is used without further workup steps for the polymerization to prepare the comb polymer.

This saves costs and time.

The monomer mixture M advantageously comprises the reaction mixture which is obtained by transesterifying the alkyl (meth)acrylate with the polyalkylene glycol capped at one end and includes, as well as the polyalkylene glycol (meth)acrylate, at least one compound selected from the group comprising alkyl (meth)acrylate, polyalkylene glycol capped at one end, transesterification catalyst and polymerization inhibitor.

It is surprisingly possible to use the monomer mixture, especially when it has been obtained by transesterifying an alkyl (meth)acrylate with a polyalkylene glycol capped at one end, very efficiently without specific purification steps for the preparation of comb polymers having block or gradient structure, especially by means of RAFT polymerization.

Preferably, the monomer mixture M comprises polyalkylene glycol (meth)acrylate and alkyl (meth)acrylate in a molar ratio of 1:0 to 1:10, preferably 1:0.01 to 1:8, especially 1:0.1 to 1:6, especially 1:0.2 to 1:4.

Advantageously, the monomer mixture M comprises, as well as the polyalkylene glycol (meth)acrylate, at least one further nonionic monomer copolymerizable with the polyalkylene glycol (meth)acrylate, especially an alkyl (meth)acrylate, vinyl acetate, styrene and/or hydroxyalkyl (meth)acrylate.

These monomers may be added to the monomer mixture M at any time between the end of the transesterification reaction or of the alkoxylation and the start of the polymerization.

Preferably, the monomer mixture M is in the form of a 10% to 90% by weight, especially 20% to 60% by weight, solution. For this purpose, after the transesterification or alkoxylation, solvent may be added to the reaction mixture. Preferred solvents are water or water-miscible organic liquids, preferably water. It may also be advantageous in specific cases when the monomer mixture M does not contain any solvent.

The aqueous monomer mixture M advantageously has a pH of 1.5 to 10, especially 2 to 8.

The comb polymer having block or gradient structure is advantageously prepared by means of living free-radical polymerization.

The techniques for living free-radical polymerization include, inter alia, nitroxide-mediated polymerization (NMP), atom transfer radical polymerization (ATRP) or reversible addition-fragmentation chain transfer polymerization (RAFT). Living free-radical polymerization proceeds essentially in the absence of irreversible transfer or termination reactions. The number of active chain ends is low and remains essentially constant during the polymerization. This is achieved, for example, in the case of RAFT polymerization by the use of a RAFT agent and only a small amount of initiator. This enables essentially simultaneous growth of the chains that continues over the entire polymerization process. This results in the option of using this process to prepare block or gradient polymers, resulting in a correspondingly narrow molecular weight distribution or polydispersity of the polymer. This is not possible in the case of conventional “free-radical polymerization” or of free-radical polymerization conducted in a non-living manner. The comb polymer having block or gradient structure is preferably prepared by means of RAFT polymerization.

Advantageous RAFT agents are dithioesters, dithiocarbamate, trithiocarbonate or xanthate.

Advantageous initiators are azobisisobutyronitrile (AIBN), α,α′-azodiisobutyramidine dihydrochloride (AAPH) or azobisisobutyramidine (AIBA).

It is preferable that the polymerization of the monomer mixture M to form the at least one section A and the further steps for preparation of the comb polymers are effected by means of living free-radical polymerization, preferably RAFT polymerization, especially directly after the transesterification, preferably in the same reactor.

This can save storage costs, transport costs and time.

It is preferable that the monomer mixture M is polymerized to form the section A by the following steps:
diluting the reaction mixture M that has been obtained by transesterifying an alkyl (meth)acrylate with a polyalkylene glycol capped at one end or by alkoxylating a hydroxyalkyl (meth)acrylate with at least one alkylene oxide, preferably with water, to 10% to 90% by weight,
optionally adding one or more monomers,
adding a RAFT agent and a polymerization initiator to the reaction mixture, and
polymerizing the reaction mixture up to a conversion of 50 to 95 mol %, based on polyalkylene glycol (meth)acrylate.

The comb polymer having block or gradient structure preferably has the following structural units:

4-68 mol %, preferably 10-40 mol %, of structural units S1 of the formula IV,
10-95 mol %, preferably 20-85 mol %, of structural units S2 of the formula V,
0-85 mol %, preferably 2-35 mol %, of structural units S3 of the formula VI and 0-50 mol % of structural units S4,

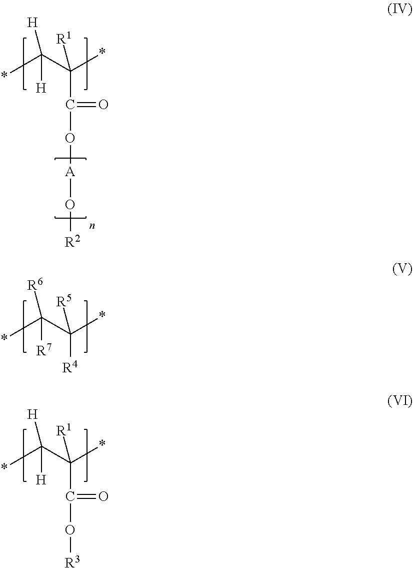

where
R¹, in each case independently, is H or —CH₃,
R², in each case independently, is H, a C₁- to C₂₀-alkyl group, -cyclohexyl group or -alkylaryl group,
R³, in each case independently, is an alkyl group having 1 to 5 carbon atoms,
R⁴, in each case independently, is —COOM, —SO₂—OM, —O—PO(OM)₂ and/or —PO(OM)₂,
R⁵, in each case independently, is H, —CH₂COOM or an alkyl group having 1 to 5 carbon atoms,
R⁶, in each case independently, is H or an alkyl group having 1 to 5 carbon atoms,
R⁷, in each case independently, is H, —COOM or an alkyl group having 1 to 5 carbon atoms,
or where R⁴ forms a ring with R⁷ to give —CO—O—CO— (anhydride),
M, independently, is H⁺, alkali metal ion, alkaline earth metal ion, di- or trivalent metal ion, ammonium ion or an organic ammonium group;
A=C₂-C₄ alkylene and
n=2 to 250, and
structural unit S4 is derived from an unsaturated monomer polymerizable into the comb polymer, especially vinyl acetate, styrene and/or hydroxyalkyl (meth)acrylate.

Structural unit S1 is present predominantly in section A, and structural unit S2 predominantly in a section of the comb polymer other than section A. Structural units S3 and S4 may, independently of one another, be present in all sections of the comb polymer having block or gradient structure.

Particularly advantageous comb polymers having block or gradient structure comprising the structural units 51, S2 and optionally S3 and/or S4 are those in which

R¹ and R⁵, in each case independently, are H or —CH₃,
R² and R³ are —CH₃,

### R⁴ is —COOM,

R⁶ and R⁷ are H,
A, in each case independently, is ethenyl or propenyl, preferably ethenyl,
n=5 to 200, especially 10 to 120, and
M, in each case independently, is H⁺, alkali metal ion or alkaline earth metal ion.

In a preferred embodiment, the comb polymer having block or gradient structure consists of structural units S1 and S2.

It may likewise be advantageous when the comb polymer contains structural units 51, S2 and S3.

Advantageously, the molar ratio of structural unit S1 to structural unit S2 in the comb polymer is 1:0.5 to 1:6, preferably 1:0.7 to 1:5, especially 1:0.9 to 1:4.5, further preferably 1:1 to 1:4, or 1:2 to 1:3.5.

Advantageously, the molar ratio of structural unit S1 to structural unit S3 in the comb polymer is 1:0 to 1:10, preferably 1:0.01 to 1:8, especially 1:0.1 to 1:6, in particular 1:0.2 to 1:4.

Advantageously, structural unit S4 is present in the comb polymer at 0 to 50 mol %, especially 2 to 35 mol %, in particular 3 to 30 mol %, or 5 to 20 mol %, based on the sum total of all structural units S1, S2, S3 and S4.

It is advantageous that the at least one section A of the comb polymer having block or gradient structure is formed on average to an extent of at least 90 mol %, preferably at least 95 mol %, especially at least 98 mol %, based on all structural units in section A, from structural units 51, S3 and/or S4, where structural unit S1 is present in section A to an extent of at least 10 mol %, preferably at least 20 mol %, more preferably at least 50 mol %.

It is preferable that the at least one section A consists to an extent of at least 90 mol % of structural units S1 and S3, where structural unit S1 is present in section A to an extent of at least 10 mol %, preferably at least 20 mol %, more preferably at least 50 mol %.

Preferably, the at least one section A of the polymer chain consists to an extent of at least 90 mol %, more preferably 95 mol %, of structural units S1.

Comb polymers having such a structure are of especially good suitability as dispersants for fine powders.

It is preferable that the comb polymer having block or gradient structure, as well as the at least one section A, also has at least one section B. It is preferable that the at least one section A is at the start of the polymer chain, “start of the polymer chain” meaning the region of the polymer backbone which is formed first in the living free-radical polymerization.

It is preferable that the at least one section B is at the end of the polymer chain, “end of the polymer chain” meaning the region of the polymer backbone which is formed last in the living free-radical polymerization. Section B is therefore preferably at the other end of the polymer chain by comparison with section A. Preferably, the at least one section B has an average of at least 40 mol %, especially at least 60 mol %, in particular at least 80 mol %, based on all structural units in section B, of structural units S2.

Preferably, the at least one section B has not more than 60 mol %, especially not more than 50 mol %, preferably not more than 40 mol %, of structural units S1.

Preferably, the at least one section B is formed directly by continuing the living free radical polymerization in which monomer mixture M has been polymerized to give section A by the steps of:
adding or metering in at least one monomer comprising acid groups and optionally further monomers to the reaction mixture present after the polymerization of monomer mixture M to give section A, and
further polymerizing the mixture thus obtained up to a conversion of at least 90 mol %, based on a monomer comprising acid groups.

Advantageously, one section of the polymer chain in each case independently has at least 5, especially at least 7, in particular at least 10, structural units.

Preferably, a section A has 5-70, especially 7-60, preferably 20-50, structural units.

Preferably, a section B has 5-70, especially 7-60, preferably 20-50, structural units.

The comb polymer advantageously also has a section C.

Section C advantageously lies between sections A and B. Section C in this case preferably forms an intermediate region between the structures of section A and those of section B.

Section C preferably comprises, as an intermediate region, structural units that are also present in sections A and B.

Section C may also comprise a self-contained region having predominantly structural units S3 and/or S4.

Section C may also be present adjoining sections A and B and comprise predominantly structural units S3 and/or S4.

Advantageously, the comb polymer has a polydispersity of below 1.5, preferably in the range from 1.0 to 1.4, especially in the range from 1.1 to 1.3.

Polydispersity is understood to mean the ratio of weight-average molecular weight Mw to number-average molecular weight Mn, both in g/mol.

The weight-average molecular weight M_{w} of the overall comb polymer is especially in the range from 8,000 to 100,000 g/mol, advantageously 10,000 to 80,000 g/mol, in particular 12,000 to 50,000 g/mol.

In the present context, molecular weights such as the weight-average molecular weight M_{w} and the number-average molecular weight Mn are determined by gel permeation chromatography (GPC) with polyethylene glycol (PEG) as standard.

A preferred process for preparing comb polymers having improved block or gradient structure comprises the following steps:
i) transesterifying an alkyl (meth)acrylate, especially methyl methacrylate, with a polyalkylene glycol capped at one end, especially polyethylene glycol monomethyl ether, having 2 to 250, preferably 10 to 120, more preferably 12 to 70, alkylene glycol units, up to a conversion of at least 60 mol %, preferably at least 70 mol %, especially at least 80 mol %, in particular at least 90 mol %, based on polyalkylene glycol capped at one end, where the molar ratio of alkyl methacrylate to polyalkylene glycol capped at one end is preferably 1:1 to 50:1, especially 1.5:1 to 20:1, in particular 2:1 to 10:1, with continuous removal of the alkyl alcohol formed from the reaction mixture,
ii) optionally distilling off excess alkyl (meth)acrylate, especially until attainment of a maximum molar ratio of alkyl (meth)acrylate to polyalkylene glycol (meth)acrylate of 10:1,
iii) diluting the reaction mixture obtained, preferably with water, to 10% to 90% by weight, especially 20% to 60% by weight,
iv) optionally adding one or more monomers, especially selected from the group comprising alkyl (meth)acrylate, vinyl acetate, styrene and hydroxyalkyl (meth)acrylate,
v) adding a RAFT agent and a polymerization initiator to the reaction mixture,
vi) polymerizing the reaction mixture up to a conversion of 50 to 95 mol %, based on polyalkylene glycol (meth)acrylate,
vii) adding or metering in at least one monomer comprising acid groups and optionally further monomers, especially selected from the group comprising alkyl (meth)acrylate, vinyl acetate, styrene and hydroxyalkyl (meth)acrylate, preferably hydroxyethyl acrylate, to the reaction mixture and
viii) further polymerizing the mixture thus obtained up to a conversion of at least 90 mol %, based on a monomer comprising acid groups.

A further preferred process for preparing comb polymers having improved block or gradient structure comprises the following steps:
i) alkoxylating a hydroxyalkyl (meth)acrylate, especially hydroxyethyl methacrylate or hydroxypropyl acrylate, with at least one alkylene oxide, especially ethylene oxide and/or propylene oxide, using a suitable catalyst, especially up to a degree of alkoxylation of 2 to 250, preferably 5 to 200, more preferably 8 to 160, especially preferably 9 to 130, in particular 10 to 120, or 12 to 70,
ii) optionally removing the catalyst and/or adding acid or alkali,
iii) diluting the reaction mixture obtained, preferably with water, to 10% to 90% by weight, especially 20% to 60% by weight,
iv) optionally adding one or more monomers, especially selected from the group comprising alkyl (meth)acrylate, vinyl acetate, styrene and hydroxyalkyl (meth)acrylate,
v) adding a RAFT agent and a polymerization initiator to the reaction mixture,
vi) polymerizing the reaction mixture up to a conversion of 50 to 95 mol %, based on polyalkylene glycol (meth)acrylate,
vii) adding or metering in at least one monomer comprising acid groups and optionally further monomers, especially selected from the group comprising alkyl (meth)acrylate, vinyl acetate, styrene and hydroxyalkyl (meth)acrylate, preferably hydroxyethyl acrylate, to the reaction mixture and
viii) further polymerizing the mixture thus obtained up to a conversion of at least 90 mol %, based on a monomer comprising acid groups.

The monomer comprising acid groups is preferably a monomer represented in polymerized form by the structural unit S2 of the formula V. The monomer comprising acid groups is preferably acrylic acid and/or methacrylic acid, more preferably methacrylic acid.

The steps for preparation of the polyalkylene glycol (meth)acrylate, i.e. steps i and ii, may be performed here separately from the polymerization, i.e. steps v to viii, especially spatially separately in different reactors, and/or separated in time by several hours, days or weeks.

Steps iii and iv may be performed here, in each case independently, either directly after step ii, especially in the same reactor, or separated in time and/or space until just before step v.

The spatial separation of the preparation of the polyalkylene glycol (meth)acrylate from the polymerization may lead to better exploitation of the reactor loads and hence to a cost saving.

It may also be advantageous when all steps i to viii are performed in one and the same reactor directly successively in time. This can likewise save costs and time, for example for transport and storage.

The invention further provides for the use of the comb polymer prepared by a process of the invention as dispersant for fine powders, especially for inorganic binders.

A suitable inorganic binder is especially a binder which reacts in the presence of water in a hydration reaction to give solid hydrates or hydrate phases.

It is especially advantageous to use the comb polymer as dispersant for a hydraulic binder which is hardenable with water, even under water, such as, in particular, cement or a latently hydraulic binder that sets under the action of additives with water, such as, in particular, foundry sand, or a pozzolanic binder, such as, in particular, fly ash or silica dust, or else gypsum hemihydrate or anhydrite.

A particular advantageous use is in cementitious applications, especially cement paste, mortar or concrete.

The comb polymers prepared by a process of the invention, in these applications, show excellent plasticizing action and only minor retardation, if any, of setting.

The invention further provides a shaped body, especially a constituent of a built structure, obtainable by curing an aqueous inorganic binder composition comprising at least one inorganic binder and a comb polymer prepared by a process as described above.

A built structure may, for example, be a bridge, a building, a tunnel, a roadway or a runway.

The comb polymers described are also of excellent suitability for dispersion of non-hydraulically setting powders. Examples of such powders are calcium carbonate, calcium hydroxide, calcium silicate hydrate (CSH) particles, coal dusts, pigments, ground cement, gypsum dihydrate or titanium dioxide.

Further advantageous embodiments of the invention will be apparent from the working examples which follow.

### EXAMPLES

### Determination of Molecular Weight and Polydispersity of the Polymers and the Solids Content of the Polymer Solutions

The weight-average molecular weight M_{w} and the number-average molecular weight Mₙ of the polymers were determined by gel permeation chromatography (GPC) with polyethylene glycol (PEG) as standard.

Column cascade used: three 8×300 mm Suprema GPC columns (10 μm, 2×1000 Å, 1×30 Å, with precolumn), from PSS Polymer Standards Service, Germany,

0.1N NaNO₃ solution, the pH of which has been adjusted to 12 with NaOH, Flow rate:
Detector: 2414 RI detector from Waters, USA,
temperature of column oven and detector: 45° C.

Polydispersity was calculated as the M_{w}/Mₙ ratio.

The solids content of the solutions was determined with an HG 63 halogen drier from Mettler Toledo, Switzerland.

### Preparation of the Monomer Mixture M1

In a three-neck flask equipped with a thermometer, stirrer and a Vigreux column with distillation attachment, 60.1 g (0.6 mol) of methyl methacrylate and 150 g (0.3 mol) of polyethylene glycol monomethyl ether (M_{w} 500) were mixed, and then 2.94 g of concentrated sulfuric acid and 2.1 g of phenothiazine were added while stirring. The reaction mixture was heated to 120° C. while stirring. The methanol formed during the reaction was distilled off continuously. After 8 hours, the temperature was increased to 135° C., and the methanol and remaining methyl methacrylate were distilled off.

### Preparation of Comb Polymer P1 Having Block Structure

Subsequent to the preparation, monomer mixture M1 was diluted with 600 ml of water in the same reaction vessel and heated to 80° C. A gentle inert gas stream (N₂) was passed through the stirred solution during the heating and throughout the remaining reaction time. 7.7 g of 4-cyano-4-(thiobenzoylthio)pentanoic acid (0.027 mol; RAFT agent) was added. Once the substance had fully dissolved, 1.34 g of azobisisobutyronitrile (0.008 mol) was added. From then on, the conversion was determined regularly by means of HPLC. As soon as the conversion, based on methoxy polyethylene glycol methacrylate, exceeded 85%, 95.3 g of methacrylic acid (1.1 mol) was added to the reaction mixture. After 2.5 hours, all the methacrylic acid had reacted according to HPLC measurement.

A reddish polymer solution was obtained. The molecular weight M_{w} of the polymer was 36,200 g/mol and the polydispersity 1.21.

### Preparation of the Comb Polymer P2 Having Gradient Structure

The preparation of the monomer mixture M1 was repeated in the same amount as described above. Subsequent to the preparation, the reaction mixture was diluted with 600 ml of water in the same reaction vessel and heated to 80° C. A gentle inert gas stream (N₂) was passed through the stirred solution during the heating and throughout the remaining reaction time. 7.7 g of 4-cyano-4-(thiobenzoylthio)pentanoic acid (0.027 mol; RAFT agent) was added. Once the substance had fully dissolved, 1.34 g of azobisisobutyronitrile (0.008 mol) was added. From then on, the conversion was determined regularly by means of HPLC. As soon as the conversion, based on methoxy polyethylene glycol methacrylate, exceeded 50%, 95.3 g of methacrylic acid (1.1 mol) was added to the reaction mixture within 20 minutes. The reaction mixture was then stirred at 80° C. for another 2 hours.

A reddish polymer solution was obtained. The molecular weight M_{w} of the polymer was 35,900 g/mol and the polydispersity 1.20.

### Monomer Mixtures M2 to M9

The monomer mixtures M2 to M9 used for the preparation of comb polymers had the composition shown in table 1.

Table 1 shows the composition of the monomer mixtures M2 to M9 in mol %, the water content of the mixtures in % by weight, and the % by weight of methacrylic acid based on methoxy polyethylene glycol-1000 methacrylate.

TABLE 1

| | | Methyl | Meth- | | % by |
|---|---|---|---|---|---|
| Monomer | MPEG- | meth- | acrylic | Water | weight of |
| mixture | 1000MA¹⁾ | acrylate | acid | content | MAA²⁾ |
| M2 | 100 | 0 | 0 | 60 | — |
| M3 | 90 | 10 | 0 | 60 | — |
| M4 | 50 | 50 | 0 | 56 | — |
| M5 | 25 | 75 | 0 | 48 | — |
| M6 | 90 | 0 | 10 | 59 | 0.9 |
| M7 | 80 | 0 | 20 | 59 | 2.0 |
| M8 | 70 | 0 | 30 | 59 | 3.5 |
| M9 | 50 | 0 | 50 | 57 | 8.1 |

¹⁾ Methoxy polyethylene glycol methacrylate having an average molecular weight of the polyethylene glycol chain of about 1,000 g/mol (corresponding to about 23 ethylene glycol units).
²⁾ % by weight of methacrylic acid based on the weight of methoxy polyethylene glycol-1000 methacrylate.

### Preparation of Comb Polymer P3 Having Block Structure

For preparation of comb polymer P3, a round-bottom flask equipped with a reflux condenser, stirrer system, thermometer and an inert gas inlet tube was initially charged with 800 g of monomer mixture M2 (0.3 mol). The reaction mixture was heated to 80° C. while stirring. A gentle inert gas stream (N₂) was passed through the solution during the heating and throughout the remaining reaction time. 7.7 g of 4-cyano-4-(thiobenzoylthio)pentanoic acid (0.027 mol; RAFT agent) was added. Once the substance had fully dissolved, 1.34 g of azobisisobutyronitrile (0.008 mol) was added. From then on, the conversion was determined regularly by means of HPLC. As soon as the conversion, based on methoxy polyethylene glycol methacrylate, exceeded 85%, 95.3 g of methacrylic acid (1.1 mol) was added to the reaction mixture. The mixture was left to react for a further 2 hours. After cooling, a reddish polymer solution was obtained, which was adjusted to a solids content of about 40% by weight by addition of water.

### Preparation of Comb Polymers P4 to P10 Having Block Structure

Comb polymers P4 to P10 were prepared analogously to comb polymer P3, except that, rather than monomer mixture M2, monomer mixtures M3 to M9 as shown in table 1 were used for comb polymers P4 to P10. Such an amount of monomer mixture that contained 0.3 mol of total monomer was used in each case.

### Tests in Mortar

### Preparation of the Mortar Mixtures

The mortar mixture used for test purposes has the dry composition described in table 2.

TABLE 2
Dry composition of the mortar mixture

| Component | Amount | |
|---|---|---|
| Cement (CEM I 42.5) | 750 | g |
| Limestone filler | 141 | g |
| Sand 0-1 mm | 738 | g |
| Sand 1-4 mm | 1.107 | g |
| Sand 4-8 mm | 1.154 | g |

To make up a mortar mixture, the sands, the limestone filler and the cement were dry-mixed in a Hobart mixer for 1 minute. Within 30 seconds, 352.5 g of mixing water into which the respective polymer according to table 3 had been mixed beforehand was added, and the mixture was stirred for a further 2.5 minutes. The total wet mixing time was 3 minutes in each case.

### Determination of Dispersing Action

To determine the dispersancy of the polymers, the slump of made-up mortar mixtures was respectively measured at different times. The slump of the mortar was determined in accordance with EN 1015-3.

### Results of the Mortar Tests

Table 3 gives an overview of the mortar tests conducted (T1 to T8). The dosage of the respective comb polymer was 0.5% by weight of a 40% by weight polymer solution, based on the weight of the cement. The W/C (weight ratio of water to cement) was 0.47.

TABLE 3
Results of the mortar tests

| | Comb | Monomer | Slump [mm] after x minutes | | | | |
|---|---|---|---|---|---|---|---|
| | polymer | mixture | 0 | 30 | 60 | 90 | 120 |
| T1 | P3 | M2 | 220 | 165 | 141 | 138 | 128 |
| T2 | P4 | M3 | 240 | 191 | 170 | 141 | 130 |
| T3 | P5 | M4 | 205 | 159 | 145 | 137 | 128 |
| T4 | P6 | M5 | 235 | 196 | 171 | 143 | 135 |
| T5 | P7 | M6 | 219 | 166 | 147 | 133 | 126 |
| T6 | P8 | M7 | 143 | 127 | —¹⁾ | — | — |
| T7 | P9 | M8 | 143 | 126 | — | — | — |
| T8 | P10 | M9 | 138 | 124 | — | — | — |

¹⁾— poor processibility, too stiff

1. A process for preparing comb polymers having block or gradient structure, wherein at least one section A of the comb polymer is formed by polymerizing a monomer mixture M comprising a polyalkylene glycol (meth)acrylate, wherein the monomer mixture M includes less than 2% by weight of (meth)acrylic acid, based on the weight of the polyalkylene glycol (meth)acrylate present in the monomer mixture M.

2. The process as claimed in claim 1, wherein the monomer mixture M includes less than 1.8% by weight of (meth)acrylic acid, based on the weight of the polyalkylene glycol (meth)acrylate present in the monomer mixture M.

3. The process as claimed in claim 1, wherein the polyalkylene glycol (meth)acrylate has been prepared by a process in which neither (meth)acrylic acid nor the anhydride of (meth)acrylic acid is used.

4. The process as claimed in claim 1, wherein the polyalkylene glycol (meth)acrylate is obtained by transesterifying an alkyl (meth)acrylate with a polyalkylene glycol capped at one end or by alkoxylating a hydroxyalkyl(meth)acrylate.

5. The process as claimed in claim 4, wherein at the start of the transesterification reaction, the molar ratio of alkyl (meth)acrylate to polyalkylene glycol capped at one end is 1:1 to 50:1.

6. The process as claimed claim 4, wherein, during and/or after the transesterification, excess alkyl (meth)acrylate is partly or fully removed from the reaction mixture.

7. The process as claimed in claim 1, wherein the monomer mixture M comprises the reaction mixture which is obtained by transesterifying an alkyl (meth)acrylate with a polyalkylene glycol capped at one end and includes, besides the polyalkylene glycol (meth)acrylate, at least one compound selected from the group comprising alkyl (meth)acrylate, polyalkylene glycol capped at one end, transesterification catalyst and polymerization inhibitor.

8. The process as claimed in claim 1, wherein the monomer mixture M comprises polyalkylene glycol (meth)acrylate and alkyl (meth)acrylate in a molar ratio of 1:0 to 1:10.

9. The process as claimed in claim 1, wherein the polymerization of the monomer mixture M to form the at least one section A and the further steps for preparation of the comb polymers are effected by means of living free-radical polymerization.

10. The process as claimed in claim 1, wherein the comb polymer having block or gradient structure has the following structural units:
4-68 mol %, of structural units S1 of the formula (IV),
10-95 mol %, of structural units S2 of the formula (V),
0-85 mol %, of structural units S3 of the formula (VI) and 0-50 mol % of structural units S4, 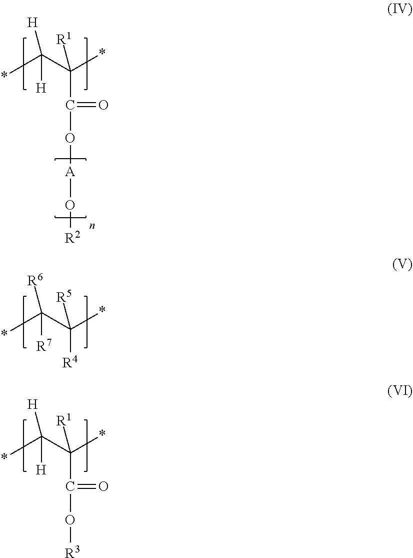
where
R¹, in each case independently, is H or —CH₃,
R², in each case independently, is H, a C₁- to C₂₀-alkyl group, -cyclohexyl group or -alkylaryl group,
R³, in each case independently, is an alkyl group having 1 to 5 carbon atoms,
R⁴, in each case independently, is —COOM, —SO₂—OM,
—O—PO(OM)₂ and/or —PO(OM)₂,
R⁵, in each case independently, is H, —CH₂COOM or an alkyl group having 1 to 5 carbon atoms,
R⁶, in each case independently, is H or an alkyl group having 1 to 5 carbon atoms,
R⁷, in each case independently, is H, —COOM or an alkyl group having 1 to 5 carbon atoms, or where R⁴ forms a ring with R⁷ to give —CO—O—CO— (anhydride),
M, independently, is H⁺, alkali metal ion, alkaline earth metal ion, di- or trivalent metal ion, ammonium ion or an organic ammonium group;
A=C₂-C₄ alkylene and
n=2 to 250, and
structural unit S4 is derived from an unsaturated monomer polymerizable into the comb polymer.

11. The process as claimed in claim 1, wherein the at least one section A of the comb polymer having block or gradient structure is formed on average to an extent of at least 90 mol %, based on all structural units in section A, from structural units S1, S3 and/or S4, where structural unit S1 is present in section A to an extent of at least 10 mol %.

12. A process for preparing comb polymers having block or gradient structure, comprising the steps of:
transesterifying an alkyl (meth)acrylate with a polyalkylene glycol capped at one end up to a conversion of at least 60 mol %, based on polyalkylene glycol capped at one end, with continuous removal of the alkyl alcohol formed from the reaction mixture,
optionally distilling off excess alkyl (meth)acrylate,
diluting the reaction mixture obtained to 10% to 90% by weight,
optionally adding one or more monomers,
adding a RAFT agent and a polymerization initiator to the reaction mixture,
polymerizing the reaction mixture up to a conversion of 50 to 95 mol %, based on polyalkylene glycol (meth)acrylate,
adding or metering in at least one monomer comprising acid groups and optionally further monomers to the reaction mixture, and
further polymerizing the mixture thus obtained up to a conversion of at least 90 mol %, based on a monomer comprising acid groups.

13. A process for preparing comb polymers having block or gradient structure, comprising the steps of:
alkoxylating a hydroxyalkyl(meth)acrylate with at least one alkylene oxide using a suitable catalyst,
optionally removing the catalyst and/or adding acid or alkali,
diluting the reaction mixture obtained to 10% to 90% by weight,
optionally adding one or more monomers,
adding a RAFT agent and a polymerization initiator to the reaction mixture,
polymerizing the reaction mixture up to a conversion of 50 to 95 mol %, based on polyalkylene glycol (meth)acrylate,
adding or metering in at least one monomer comprising acid groups and optionally further monomers to the reaction mixture, and
further polymerizing the mixture thus obtained up to a conversion of at least 90 mol %, based on a monomer comprising acid groups.

14. A dispersant suitable for use with fine powders, wherein the dispersant comprises the comb polymer prepared by a process as claimed in claim 1.

15. A shaped body obtainable by curing an aqueous inorganic binder composition comprising at least one inorganic binder and a comb polymer prepared by a process as claimed in claim 1.
